(19) United States
(12) Patent Application Publication
(10) Pub. No.: US 2015/0000435 A1
(43) Pub. Date: Jan. 1, 2015

(54) SUPPORTING APPARATUS FOR DISPLAY

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: GUANG-LEI ZHANG, Wuhan (CN); XIAO-ZHONG JING, Wuhan (CN); YI-TING HSIEH, New Taipei (TW); GUANG-YAO LEE, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/945,918

(22) Filed: Jul. 19, 2013

(30) Foreign Application Priority Data
Jun. 28, 2013 (CN) 2013102653489

(51) Int. Cl. F16H 19/08

(52) U.S. Cl. CPC F16H 19/08
USPC 74/89.16

(57) ABSTRACT

A power-assisted supporting apparatus includes a base, a supporting member, and a drive mechanism connected between the base and the supporting member. The drive mechanism includes a motor, a gear assembly, and a controller controlling the motor. The motor includes a drive gear driving the gear assembly. The gear assembly includes a connecting shaft connected to the supporting member. The user presses buttons to instruct the controller to activate the motor, and the drive gear drives the gear assembly to rotate an electronic device which is held by the supporting member.

### BACKGROUND

1. Technical Field

The present disclosure relates to an supporting apparatus for supporting a display of an electronic device.

2. Description of Related Art

An electronic device, such as an all-in-one computer, can include a display and a supporting apparatus supporting the display. The supporting apparatus usually includes a base and a supporting member. The supporting member includes a first end supporting the display and a second end connected to the base. A shaft is rotatably connected between the second end of the supporting member and the base. However, the supporting member often needs to be rotated manually relative to the base, which is inconvenient in use.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded view of an embodiment of a supporting apparatus, wherein the supporting apparatus includes a drive mechanism.

FIG. 2 is similar to FIG. 1, but the supporting apparatus is viewed from another perspective.

FIG. 3 is an enlarged, exploded view of the drive mechanism of FIG. 1.

FIG. 4 is similar to FIG. 3, but the drive mechanism is viewed from another perspective.

FIG. 5 is an assembled view of the supporting apparatus of FIG. 2.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

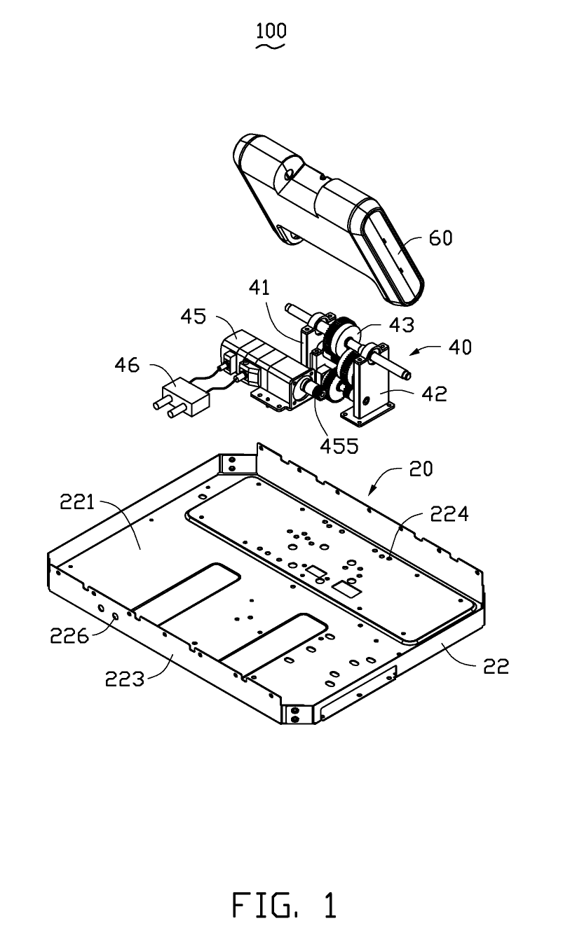

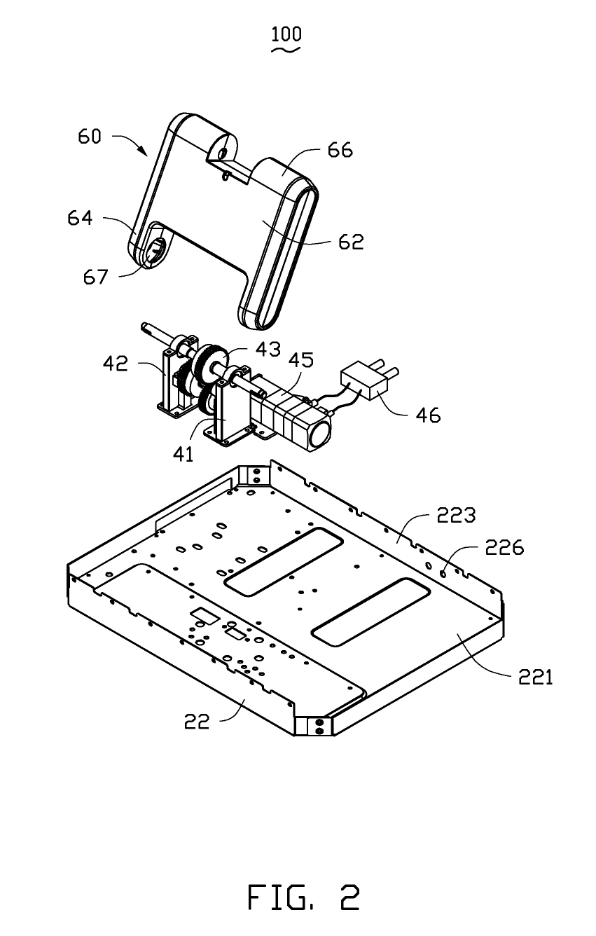

FIG. 1 and FIG. 2 show an embodiment of a supporting apparatus 100 including a base 20, a drive mechanism 40, and a supporting member 60. The supporting member 60 supports an electronic device (not shown), such as a display.

The base 20 includes a shell 22. The shell 22 includes a bottom plate 221 and a front plate 223 perpendicularly extending up from a front side of the bottom plate 221. A middle of a rear side of the bottom plate 221 defines a plurality of mounting holes 224. An end of the front plate 223 defines a plurality of through holes 226.

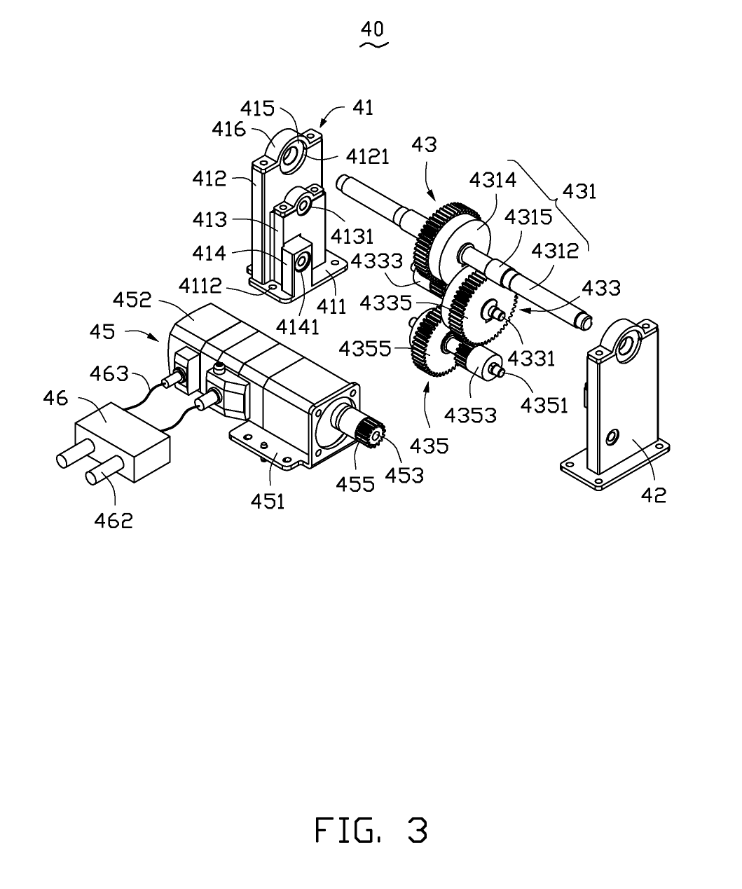

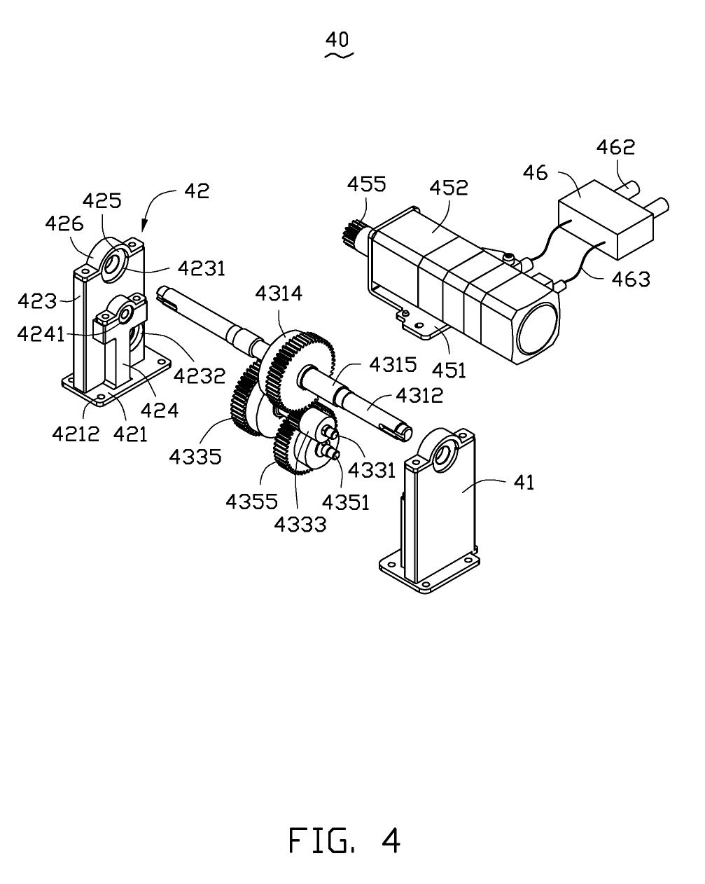

FIG. 3 and FIG. 4 show the drive mechanism 40 including a first bracket 41, a second bracket 42, a gear assembly 43, a motor 45, and a controller 46.

The first bracket 41 includes a mounting plate 411, a first supporting plate 412 perpendicularly extending up from a side of the mounting plate 411, a second supporting plate 413 on the inside of a lower portion of the first supporting plate 412 and connected to the mounting plate 411, a third supporting plate 414 on the inside of a lower portion of the second supporting plate 413 and opposite to the first supporting plate 412, three bearings 415, and two bearing covers 416. A top of the first supporting plate 412 defines a cutout 4121. A top of the second plate 413 defines a cutout 4131. An upper portion of the third supporting plate 414 defines a position hole 4141. The bearings 415 are mounted in the cutouts 4121 and 4131 and the position hole 4141. The bearing covers 416 are mounted on tops of the first and second supporting plates 412 and 413, and secure in place two of the bearings 415. The mounting plate 411 defines a plurality of through holes 4112.

The second bracket 42 includes a mounting plate 421, a fourth supporting plate 423 perpendicularly extending up from a middle of the mounting plate 421, a T-shaped fifth supporting plate 424 protruding from a lower portion of the fourth supporting plate 423 and connected to the mounting plate 421, three bearings 425, and two bearing covers 426. A top of the fourth supporting plate 423 defines a cutout 4231, and a lower portion of the fourth supporting plate 423 defines a position hole 4232. A top of the fifth supporting plate 424 defines a cutout 4241. The bearings 425 are mounted in the cutouts 4231 and 4241, and in the position holes 4232. The bearing covers 426 are mounted on tops of the fourth and fifth supporting plates 423 and 424, for fixing two of the bearings 425. The mounting plate 421 defines a plurality of through holes 4212.

The gear assembly 43 includes a first gear set 431, a second gear set 433, and a third gear set 435. The first gear set 431 includes a connecting shaft 4312 and a bull gear 4314 mounted to a middle of the connecting shaft 4312. Two latching sleeves 4315 are mounted to the two ends of the connecting shaft 4312. The latching sleeves 4315 are located adjacent to the bull gear 4314. The second gear set 433 includes a rotation shaft 4331, a bull gear 4335 mounted to a first end of the rotation shaft 4331, and a pinion 4333 mounted to a second end of the rotation shaft 4331 opposite to the bull gear 4335. The pinion 4333 engages with the bull gear 4314 of the first gear set 431. The third gear set 435 includes a pivot 4351, a pinion 4353 mounted to a first end of the pivot 4351, and a bull gear 4355 mounted to a second end of the pivot 4351 opposite to the pinion 4353. The pinion 4353 of the third gear set 435 engages with the bull gear 4335 of the second gear set 433.

The motor 45 includes a support 451, a main body 452 mounted on the support 451, a drive shaft 453 extending out from an end of the main body 452, and a drive gear 455 mounted a distal end of the drive shaft 453.

The controller 46 includes a plurality of buttons 462 and cables 463 electrically connected between the controller 46 and the motor 45.

The supporting member 60 is substantially H-shaped, and includes a rectangular connecting plate 62, two opposite first connecting blocks 64 protruding out from opposite ends of a first side of the connecting plate 62, and two opposite second connecting blocks 66 protruding out from opposite ends of a second side of the connecting plate 62. The first connecting blocks 64 are opposite to the second connecting blocks 66. Distal ends of the first connecting blocks 64 opposite to the connecting plate 62 define two opposite mounting holes 67.

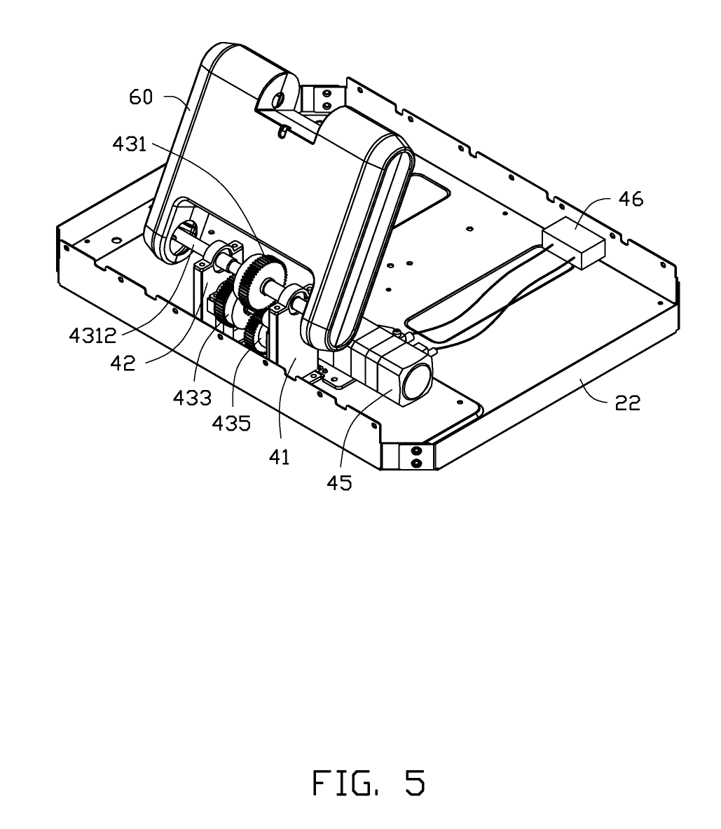

FIG. 5 shows that in assembling the supporting apparatus 100, the gear assembly 43 is placed between the first bracket 41 and the second bracket 42, to allow the second supporting plate 413 of the first bracket 41 to face the fifth supporting plate 424 of the second bracket 42. Two distal ends of the connecting shaft 4312 extend through the bearing 415 mounted in the first supporting plate 412 and the bearing 425 mounted in the top of the fourth supporting plate 423. The latching sleeves 4315 are engaged in the bearing 415 mounted in the first supporting plate 412 and the bearing 425 mounted in the fourth supporting plate 423. Two distal ends of the rotation shaft 4331 are latched in the bearing 415 mounted in the second supporting plate 413 and the bearing 425 mounted in the fifth supporting plate 424. Two distal ends of the pivot 4351 are latched in the bearing 415 mounted in the third supporting plate 414 and the bearing 425 mounted in the position hole 4232 of the fourth supporting plate 423.

The first bracket 41, the second bracket 42, and the gear assembly 43 are placed on the bottom plate 221, and the bull gear 4355 of the third gear set 435 is adjacent to the front plate 223. Screws extend through the through holes 4112 and 4212 of the mounting plates 411 and 421, to be screwed in the mounting holes 224 of the shell 22. The motor 45 is placed on the bottom plate 221, to allow the drive gear 455 to engage with the bull gear 4355 of the third gear set 435. A plurality of fasteners extends through the support 451, to be mounted to the bottom plate 221. The buttons 462 are inserted in the through holes 226 from an inside of the shell 22. The controller 46 is mounted in the shell 22, and the buttons 462 are exposed out of the front plate 223 through the through holes 226. The connecting shaft 4312 is placed between the first connecting blocks 64. The distal ends of the connecting shaft 4312 are latched in the mounting holes 67 of the first connecting blocks 64. The electronic device is held between the second connecting blocks 66.

In use, by means of operating the buttons 462, the controller 46 controls the motor 45 to operate. The drive shaft 453 rotates. Thus, the drive gear 455 of the motor 45 drives the gear assembly 43 to rotate. The gear assembly 43 drives the connecting shaft 4312 to rotate, which rotates the supporting member 60.

It is to be understood, however, that even though numerous characteristics and advantages of the embodiment have been set forth in the foregoing description, together with details of the structure and function of the embodiment, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A supporting apparatus, comprising:
a base;
a supporting member; and
a drive mechanism connected between the base and the supporting member, and comprising a motor comprising a drive shaft and a drive gear mounted to the drive shaft, a gear assembly connected to the drive shaft and comprising a connecting shaft connected to the supporting member, and a controller controlling the motor to operate, thereby allowing the drive gear to drive the gear assembly to rotate the supporting member.

2. The supporting apparatus of claim 1, wherein the gear assembly comprises a first gear set, a second gear set, and a third gear set, the first gear set comprises a first bull gear mounted to the connecting shaft, the second gear set comprises a rotation shaft, a second bull gear mounted to a first end of the rotation shaft, and a first pinion mounted to a second end of the rotation shaft, the third gear set comprises a pivot, a second pinion mounted to a first end of the pivot, and a third bull gear mounted to a second end of the pivot, the first pinion engages with the first bull gear, the second pinion engages with the second bull gear, and the drive gear engages with the third bull gear.

3. The supporting apparatus of claim 2, wherein the drive mechanism further comprises a first bracket and a second bracket opposite to the first bracket, the first and second brackets are mounted on the base, the gear assembly is mounted between the first and second brackets.

4. The supporting apparatus of claim 3, wherein the first bracket comprises a first supporting plate, a second supporting plate protruding from a lower portion of the first supporting plate toward the second bracket, and a third supporting plate protruding from a lower portion of the second supporting plate toward the second bracket, the second bracket comprises a fourth supporting plate opposite to the first supporting plate and a fifth supporting plate protruding from a lower portion of the fourth supporting plate toward the first bracket, the connecting shaft is connected between the first supporting plate and an upper portion of the fourth supporting plate, the rotation shaft is connected between the second supporting plate and the fifth supporting plate, and the pivot is connected between the third supporting plate and a lower portion of the fourth supporting plate.

5. The supporting apparatus of claim 4, wherein two bearings are mounted to an upper portion of the first supporting plate and an upper portion of the fourth supporting plate, two ends of the connecting shaft is mounted the bearings.

6. The supporting apparatus of claim 4, wherein two bearings are mounted to an upper portion of the second supporting plate and an upper portion of the fifth supporting plate, two distal ends of the rotation shaft are mounted to the bearings.

7. The supporting apparatus of claim 4, wherein two bearings are mounted to an upper portion of the third supporting plate and the lower portion of the fourth supporting plate, two distal ends of the pivot are mounted to the bearings.

8. The supporting apparatus of claim 4, wherein the first bracket further comprises a first mounting plate mounted to the base, the second bracket further comprises a second mounting plate mounted to the base, the first to third supporting plates are connected to the first mounting plate, and the fourth and fifth supporting plates are connected to the second mounting plate.

9. The supporting apparatus of claim 1, wherein the motor further comprises a support mounted to the base, and a main body mounted on the support, the drive shaft extends from the main body.

10. The supporting apparatus of claim 1, wherein the controller comprises a plurality of buttons exposed out of the base and a cable electrically connected between the controller and the motor.

11. The supporting apparatus of claim 1, wherein the supporting member comprises a connecting plate, two opposite connecting blocks protruding out from two opposite ends of a side of the connecting plate, the connecting blocks define two opposite mounting holes, two distal ends of the connecting shaft are mounted in the mounting holes.
